(19) United States
(12) Patent Application Publication
(10) Pub. No.: US 2026/0132916 A1
(43) Pub. Date: May 14, 2026

(54) LAMP WITH ELECTRIC CONTROL BOX, ELECTRIC CONTROL BOX AND HEAT DISSIPATION BOX

(71) Applicant: DONGGUAN THAILIGHT SEMICONDUCTOR LIGHTING CO., LTD, Dongguan City (CN)

(72) Inventor: Wenbo ZHOU, Dongguan (CN)

(21) Appl. No.: 19/306,540

(22) Filed: Aug. 21, 2025

(30) Foreign Application Priority Data
Nov. 14, 2024 (CN) 202411632571.7

(51) Int. Cl. F21V 29/507; F21S 9/03; F21V 23/00; F21V 23/02; F21V 29/508; F21V 29/67; F21V 31/00; F21V 31/03; F21W 131/10

(52) U.S. Cl. CPC F21V 29/507; F21S 9/037; F21V 23/008; F21V 23/023; F21V 29/508; F21V 29/673; F21V 29/677; F21V 31/005; F21V 31/03; F21W 2131/10

(57) ABSTRACT

The present application discloses a heat dissipation box, an electric control box and a lamp, the lamp including: the electric control box, a lamp body and a supporting base; the supporting base is configured to support the electric control box and the lamp body; the electric control box includes the heat dissipation box and an electric component, the electric component is electrically connected to the lamp body, the heat dissipation box includes: a housing extends along a horizontal direction, and an accommodating space configured to accommodate the electric component is provided in the housing; an air inlet fan provided close to a front side surface of the housing, and the air inlet fan is configured to draw external gas into the accommodating space.

### CROSS-REFERENCE TO RELATED APPLICATION

This application claims priority to Chinese Patent Application No. CN202411632571.7 filed on Nov. 14, 2024, the entire content of which is hereby incorporated by reference.

### FIELD OF TECHNOLOGY

The present application relates to the technical field of heat dissipation, and in particular to a lamp with an electric control box, an electric control box and a heat dissipation box.

### BACKGROUND

Lamps are indispensable lighting equipment in modern life. Specifically, outdoor streetlights can provide illumination for roads at night, reducing nighttime accidents. As photovoltaic technology improves, solar-powered streetlights have emerged in recent years. The solar-powered streetlights can convert solar energy collected during daytime into electrical energy, and store it in batteries for nighttime illumination.

However, since the streetlights are installed outdoors, their electric components such as batteries are also installed outdoors and exposed to sunlight and rain. In order to prevent them from being damaged from rain etc., a protective housing is provided on an outside of electric components such as batteries. However, the applicant found that during operation, the electric components such as batteries generate heat, the heat generated by electric components provided in the protective housing is not easy to be dissipated to an outside. This heat accumulation often leads to frequent malfunctions of electronic devices.

Furthermore, an electric control box and a heat dissipation box are disclosed in the present application.

### SUMMARY

According to an aspect of this disclosure, a lamp with electric control box is disclosed and includes:
an electric control box, a lamp body and a supporting base; in which, the supporting base is configured to support the electric control box and the lamp body; the electric control box includes a heat dissipation box and an electric component, the electric component is electrically connected to the lamp body, and the heat dissipation box includes:
a housing, in which, the housing extends along a horizontal direction, and an accommodating space configured to accommodate the electric component is provided in the housing;
an air inlet fan, in which, the air inlet fan is provided close to a front side surface of the housing, and the air inlet fan is configured to draw external gas into the accommodating space;
an air outlet fan, in which, the air outlet fan is provided close to the front side surface of the housing and is separated from the air inlet fan by a distance in a horizontal direction, the air outlet fan is configured to discharge gas inside the accommodating space to an exterior of the housing;
a protection unit, in which, the protection unit includes a supporting bracket and a protective cover; the supporting bracket is provided on an outer side of the front side surface of the housing, a perforation is provided on a middle portion of supporting bracket, the perforation is configured to form a communication between the accommodating space and an exterior, the perforation is located close to the air inlet fan and/or the air outlet fan; the protective cover is a semi-enclosed box with an opening provided at one end of the semi-enclosed box, the protective cover is covered on the supporting bracket, a least a portion of an inner wall of the protective cover is separated from the supporting bracket to form a gas channel communicated with the perforation and the housing.

### BRIEF DESCRIPTION

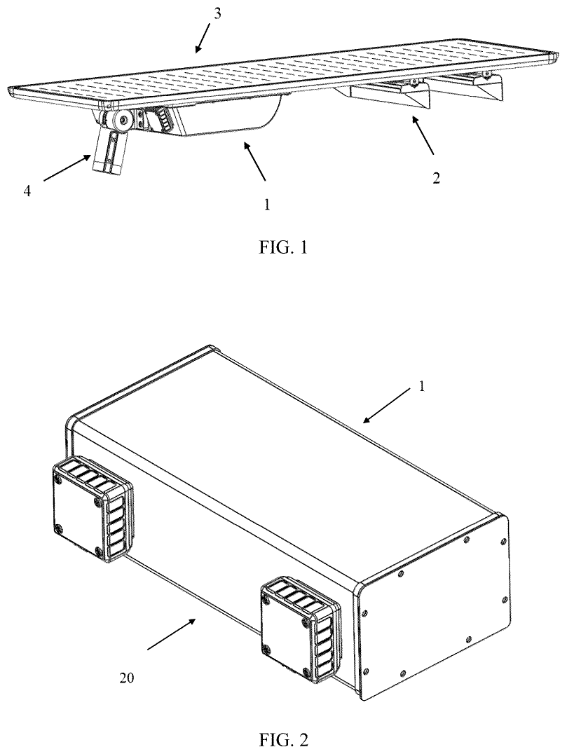

FIG. 1 is a schematic overall structural diagram of a lamp with an electric control box of the present application;

FIG. 2 is a schematic overall structural diagram of the electric control box of the present application;

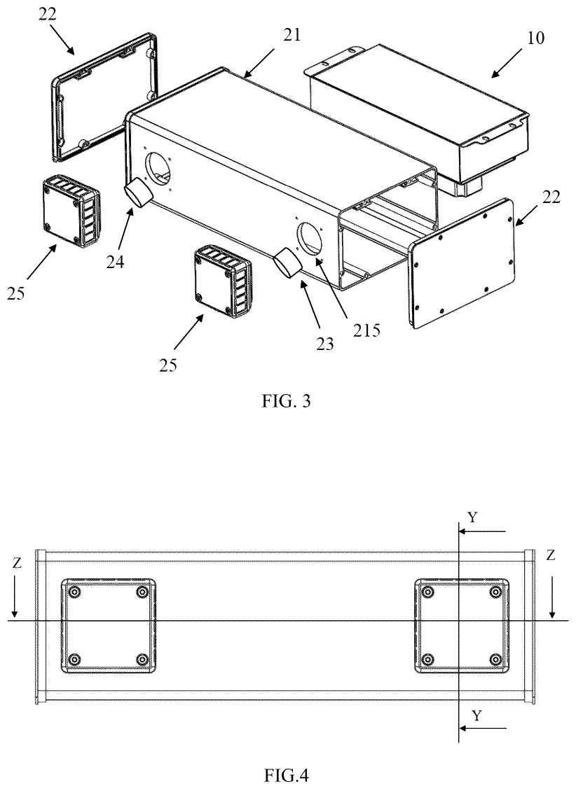

FIG. 3 is an exploded diagram of the electric control box of the present application;

FIG. 4 is a front view of the electric control box of the present application;

FIG. 5 is a cross-sectional view along a direction Y-Y in FIG. 4;

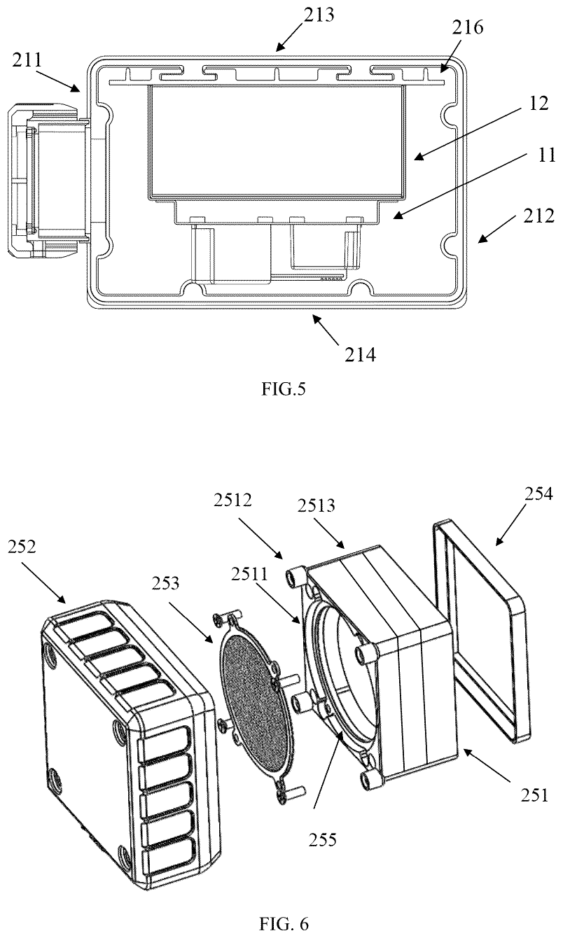

FIG. 6 is an exploded diagram of a protection unit of the present application;

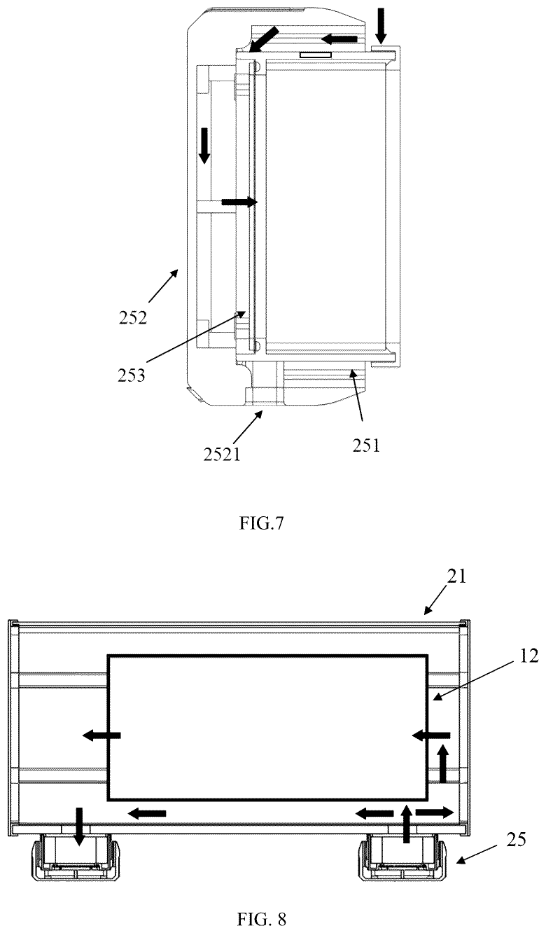

FIG. 7 is a partial enlarged diagram of a portion A in FIG. 5;

FIG. 8 is a cross-sectional view along a direction Z-Z in FIG. 4;

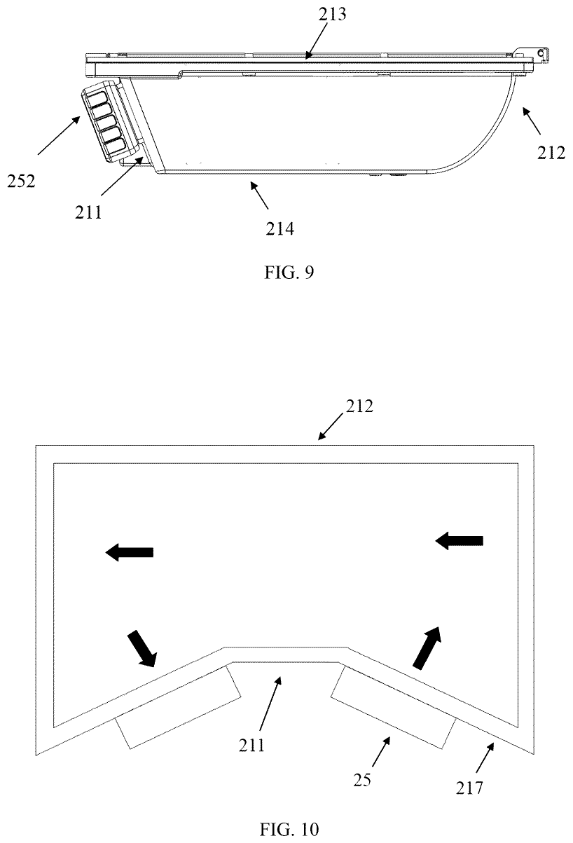

FIG. 9 is a left side view of an electric control box in another embodiment; and

FIG. 10 is a cross-sectional view of an electric control box in another embodiment when projected along a perpendicular direction.

Illustration of reference signs: 1, electric control box; 10, electric component 11, substrate; 12, battery; 20, heat dissipation box; 21, housing; 211, front side surface; 212, rear side surface; 213, upper side surface; 214, lower side surface; 215, mounting hole; 216, mounting protrusion; 217, mounting portion; 22, end cover; 23, air inlet fan; 24, air outlet fan; 25, protection unit; 251, supporting bracket; 2511, perforation; 2512, protruding block; 2513, draining grooves; 252, protective cover; 2521, drain hole; 253, filter net; 254, first sealing element; 255, second sealing element; 2, lamp body; 3, solar panel; 4, supporting base.

### DETAILED DESCRIPTION

The applicant of the present application conducted a research on an issue of frequent failures of existing lamps, particularly outdoor lamps, and discovered conflicting requirements in their structural designs. Electric components such as batteries need to be tightly wrapped by a housing to prevent exposure to rainwater, dust, and other foreign substances, while also requiring a well-ventilated environment for rapid heat dissipation. In order to solve this contradiction, the applicant of the present application provides a lamp with an electric control box. The electric control box utilizes dual fans to ensure that airflow within a housing conducts sufficient heat exchange, thereby dissipating heat. Additionally, a fan upper cover is provided with a uniquely structured protection unit that reduces an ingress of rainwater, dust, and other foreign substances into the housing. This design achieves dual purpose of not impeding heat dissipation, while protecting the electric components. The technical solution is detailed in the following embodiments.

Please refer to FIG. 1. The lamp with the electric control box of the present application includes the electric control box 1, a lamp body 2, a solar panel 3 and a supporting base 4. The electric control box 1, the lamp body 2 and the supporting base 4 are installed below the solar panel 3. The supporting base 4 is located on one side away from the lamp body 2. The electric control box 1 is located between the supporting base 4 and the lamp body 2. The supporting base 4 is configured to be connected to supporting elements such as a lamp post, allowing an entire lamp with the electric control box to be installed at a high position.

Please refer to FIGS. 2-5. The electric control box 1 includes an electric component 10 and a heat dissipation box 20.

The electric component 10 includes a substrate 11 and a battery 12. The substrate 11 and the battery 12 are stacked and electrically connected to each other. The lamp body 2 and the solar panel 3 are electrically connected to the substrate 11, respectively. The solar panel 3 converts light energy into electrical energy through the substrate 11 and supplies power to the lamp body 2, with excess electrical energy stored in the battery 12.

The heat dissipation box 20 includes a housing 21, an end cover 22, an air inlet fan 23, an air outlet fan 24 and a protection unit 25. In this embodiment, the housing 21 extends along a horizontal direction. The housing 21 is hollow inside and an opening is provided on each end of two opposite ends of the housing 21 in a horizontal direction. The end cover 22 is covered on the opening provided on each end of two ends of the housing 21, thus forming an accommodating space. The electric component 10 is installed in the accommodating space. A front side surface 211 of the housing 21 faces toward the supporting base 4. Two mounting holes 215 are provided on the front side surface 211 of the housing 21, arranged along a left-right direction and are separated from each other by a distance. The air inlet fan 23 and the air outlet fan 24 are provided close to the two mounting holes 215 respectively, and are electrically connected to the substrate 11, allowing external air to be blown into the accommodating space and air inside the accommodating space to be discharged from the accommodating space; in this embodiment, the air inlet fan 23 and/or the air outlet fan 24 is located at an inner side of the front side surface 211, or passes through the mounting hole 215, so that at least a portion of the air inlet fan 23 and/or the air outlet fan 24 is located at an outer side of the front side surface 211. Furthermore, a mounting protrusion 216 is provided on an inner top wall of the housing 21. The mounting protrusion 216 protrudes toward the accommodating space. The electric component 10 is fixed to the mounting protrusion 216 using screws, etc. and is separated from an inner bottom wall of the housing 21 by a distance, thus preventing water accumulation inside the housing 21 from affecting the electric component 10. In this embodiment, the housing 21 includes the front side surface 211 and a rear side surface 212, which extend along an up-down direction and are arranged opposite each other, and an upper side surface 213 and a lower side surface 214, which are arranged along an up-down direction and are respectively connected between the front side surface 211 and the rear side surface 212. The lamp body 2 is located at one side close to the rear side surface 212.

Please refer to FIGS. 5-8. The protection unit 25 is covered on an outer side of each mounting hole of the two mounting holes 215. The protection unit 25 includes a supporting bracket 251, a protective cover 252, a filter net 252, a first sealing element 254 and a second scaling element 255. The supporting bracket 251 is provided on an outside of the front side surface 211 of the housing 21, a perforation 2511 communicated with the mounting hole 215 is provided on a middle portion of the supporting bracket 251. In one embodiment, the mounting hole 215 is coaxial with the perforation 2511, and a pore diameter of the perforation 2511 is larger than or equal to a pore diameter of the mounting hole 215. The perforation 2511 surrounds an outside of the mounting hole 215. The air inlet fan 23 or the air outlet fan 24 is located in the perforation 2511. In this embodiment, when projected along an axis of the perforation 2511, an outer contour of the supporting bracket 251 is a rectangle defined by an upper side surface, a lower side surface, a left side surface and a right side surface, and the perforation 2511 is located at its central portion. The filter net 253 is covered on one side of the perforation 2511 oriented away from the housing 21 to prevent foreign objects from entering the housing 21 through the perforation 2511. The protective cover 252 is a semi-enclosed box with an opening provided at one end of the semi-enclosed box. The opening faces toward the supporting bracket 251. The protective cover 252 is covered on one side of the supporting bracket 251 oriented away from the housing 21, fixed to the supporting bracket 251 through screws etc., and is separated from a side surface of the supporting bracket 251 by a distance. The filter net 253 is provided between the supporting bracket 251 and the protective cover 252. In this embodiment, the protective cover 252 surrounds an outer side of the upper side surface, the lower side surface, the left side surface and the right side surface of the supporting bracket 251, and is separated from them by a distance. When projected along an axis of the perforation 2511, a protruding block 2512 protrudes toward a direction of the protective cover 252 is provided on each corner of four corners of the supporting bracket 251. An inner side wall of the protective cover 252 facing toward the supporting bracket 251 abuts on the protruding block 2512, allowing an inner side wall of the protective cover 252 to be separated from the perforation 2511 by a distance, thus forming a gas channel communicated with the perforation 2511. The first scaling element 254 and the second sealing element 255 are sealing rings made of materials such as rubber. The first sealing element 254 is provided between the supporting bracket 251 and the housing 21 to seal a gap between the supporting bracket 251 and the housing 21. The second scaling element 255 is provided between the filter net 253 and the supporting bracket 251, and surrounds the perforation 2511 to seal a gap between the filter net 253 and the supporting bracket 251.

In one embodiment, a plurality of drain holes 2521 are provided on a bottom of the protective cover 252, rainwater entering the protective cover 252 may drain out through the plurality of drain holes 2521, preventing rainwater from accumulating inside the protective cover 252. In this embodiment, the plurality of drain holes 2521 are provided on a bottom wall surface of the protective cover 252 facing toward the lower side surface of the supporting bracket 251 and are provided away from the supporting bracket 251, allowing rainwater to quickly drain out of the protective cover 252. Furthermore, an inner bottom surface of the protective cover 252 is inclined toward a direction of the plurality of drain holes 2521 to accelerate draining of rainwater.

In one embodiment, draining grooves 2513 communicated with each other are provided on the upper side surface, the left side surface and the right side surface of the supporting bracket 251. Through the draining grooves 2513 extending from a top of the supporting bracket 251 to a bottom of the supporting bracket 251, a part of rainwater entering the protective cover 252 from the top is able to be directed toward the plurality of drain holes 2521.

In one embodiment, please refer to FIG. 9, the front side surface 211 of the housing 21 is provided inclined with respect to a perpendicular direction, so that a distance between one side of the front side surface 211 connected to the lower side surface 214 and the rear side surface 212 is smaller than a distance between one side of the front side surface 211 connected to the upper side surface 213 and the rear side surface 212, and the protection unit 25 is provided inclined accordingly. An outer side surface of an upper part of the protective cover 252 is inclined toward one side oriented away from the housing 21, an outer side surface of a lower part of the protective cover 252 is inclined toward the housing 21. Each drain hole of the plurality of drain holes 2521 faces toward the housing 21. When rainwater falls onto the upper part of the protective cover 252, it does not easily enter the protective cover 252, and rainwater inside the protective cover 252 easily flows out of the protective cover 252.

In one embodiment, please refer to FIG. 10. When projected along a perpendicular direction, two mounting portions 217 inclined with respect to each other are provided on the front side surface 211 of the housing 21. The two mounting portions 217 extend from a central portion to end covers 22 located on left side and right side, respectively, and distances between the two mounting portions 217 and the rear side surface 212 are gradually increase. The air inlet fan 23, the air outlet fan 24, the protection unit 25 and the two mounting holes 215 are respectively provided on the two mounting portions 217, so that the air inlet fan 23 and the air outlet fan 24 are inclined with respect to each other. An airflow drawn in by the air inlet fan 23 predominantly flows toward an end cover 22 located on one side, then rebounds and flows towards an end cover 22 located on the other side, and subsequently rebounds toward the air outlet fan 24. This extends a duration for which gas remains within the accommodating space, thereby allowing a more thorough heat exchange.

Please refer to FIG. 7 and FIG. 8, airflows are as indicated by arrows in the diagram. During operation, the air inlet fan 23 creates a negative air pressure, causing air to flow into the protective cover 252 from the opening of the protective cover 252 covered on the air inlet fan 23 along the upper side surface, the lower side surface, the left side surface, and the right side surface of the supporting bracket 251. Then, the air reaches the perforation 2511 and flows into the accommodating space, and flows toward the air outlet fan 24 under an action of the air outlet fan 24. Under a pushing action of the air outlet fan 24, the air exits the accommodating space through the perforation 2511 of the supporting bracket 251 covered on the air outlet fan 24, then flows out from the protective cover 252 covered on the air outlet fan 24 and the supporting bracket 251, and finally flows from the protective cover 252 to an external space, thus carrying away heat in the accommodating space. In this process, since the air inlet fan 23 and the air outlet fan 24 are located on the same side of the housing 21, incoming gas needs to flow through an entire interior of the housing 21 before exiting. This ensures the gas to fully contact with the substrate 11 and the battery 12 in the accommodating space and carry away their heat, achieving excellent heat dissipation performance. The protective housing 252 and the supporting bracket 251 surround an outer side of the air inlet fan 23 and/or the air outlet fan 24, gas needs to flow through a circuitous gas channel to enter the accommodating space, thereby reducing an ingress of rain, dust, etc. into the interior of the accommodating space.

Additionally, the lamp of the present application is solar powered, but according to requirements, the lamp of the present application may also be powered by other external direct current or alternating current power supplies. The heat dissipation box 20 may also accommodates other heating elements for protection and heat dissipation.

The lamp with the electric control box of the present application has following advantages:
1. It enables heat dissipation of an interior of the electric control box while reducing the ingress of rainwater, dust, and other foreign objects into the electric control box.
2. It quickly discharges rainwater accumulated in the protection unit.
3. It provides excellent sealing performance.
4. Airflows enter the electric control box from multiple directions, improving airflows inside the electric control box.
5. The electric components inside the electric control box are less likely to come into contact with rainwater or other foreign objects.
6. It features a compact structure, occupies less space, and causes minimal obstruction to lighting.

The terms used in the embodiments of the present application are merely for the purpose of describing specific embodiments, and are not intended to limit the present application. The terms “a”, “the” and “this” used in a singular form in the embodiments and the appended claims of the present application indicate that a related object may be in a singular form or may be in a plural form, unless otherwise specified clearly in the context. It should be further understood that unless otherwise indicated, “a plurality of” means two or more; the terms “first”, “second”, “third”, etc. are used only to distinguish similar objects and need not be used to describe a particular order or sequence, nor are they to be understood as indicative of or suggestive of relative importance. The term “and/or” used herein are intended to signify and include any or all possible combinations of one or more of the associated listed items. When the above description relates to the accompanying drawings, the same numbers in different accompanying drawings represent the same or similar elements, unless otherwise specified. In the description of the present application, for those skilled in the art, the specific meanings of the above terms in the present application can be understood on a case-by-case basis.

The above-mentioned embodiments only represent several implementations of the present application, and descriptions thereof are specific and detailed, but should not be construed as a limitation on the application scope of the present application. It should be noted that, for those skilled in the art, several variations and improvements may be made without departing from the concept of the present application, and these are all within the protection scope of the present application.

What is claimed:

1. A lamp with an electric control box, comprising: an electric control box, a lamp body and a supporting base; wherein, the supporting base is configured to support the electric control box and the lamp body; the electric control box comprises a heat dissipation box and an electric component, the electric component is electrically connected to the lamp body, wherein, the heat dissipation box comprises:
a housing, wherein, the housing extends along a horizontal direction, and an accommodating space configured to accommodate the electric component is provided in the housing;
an air inlet fan, wherein, the air inlet fan is provided close to a front side surface of the housing, and the air inlet fan is configured to draw external gas into the accommodating space;
an air outlet fan, wherein, the air outlet fan is provided close to the front side surface of the housing and is separated from the air inlet fan by a distance in a horizontal direction, the air outlet fan is configured to discharge gas inside the accommodating space to an exterior of the housing;
a protection unit, wherein, the protection unit includes supporting brackets and protective covers; the supporting brackets are provided on an outer side of the front side surface of the housing, a perforation is provided on a middle portion of each supporting bracket, the perforation is configured to form a communication between the accommodating space and an exterior, the perforations are located close to the air inlet fan and the air outlet fan respectively; each protective cover is a semi-enclosed box with an opening provided at one end of the semi-enclosed box, each protective cover is covered on each supporting bracket, a least a portion of an inner wall of the protective cover is separated from the supporting bracket to form a gas channel communicated with the perforation and the housing.

2. The lamp with an electric control box of claim 1, wherein, the protection unit further comprises a filter net, the filter net is covered on the perforation and is located close to the protective cover.

3. The lamp with an electric control box of claim 2, wherein, the protection unit further comprises a first sealing element and a second sealing element; the first sealing element is configured to seal a gap between the supporting bracket and the front side surface of the housing; the second sealing element is configured to seal a gap between the filter net and the supporting bracket.

4. The lamp with an electric control box of claim 1, wherein, the front side surface of the housing extends along a perpendicular direction; a drain hole facing downward is provided on a bottom of the protective cover, the drain hole is located close to an inner side wall of the protective cover facing toward the perforation.

5. The lamp with an electric control box of claim 1, wherein, a drain hole located close to an inner side wall of the protective cover facing toward the perforation is provided on a bottom of the protective cover, the housing further includes a rear side surface opposite to the front side surface, the rear side surface extends along a perpendicular direction; the front side surface is inclined with respect to a perpendicular direction, and a distance between an upper side of the front side surface and the rear side surface is smaller than a distance between a lower side of the front side surface and the rear side surface, causing the drain hole to incline toward the front side surface.

6. The lamp with an electric control box of claim 5, wherein, a mounting protrusion protruding toward the accommodating space is provided in an inner top wall of the housing, the electric component is installed on the mounting protrusion and is separated from the inner top wall of the housing by a distance.

7. The lamp with an electric control box of claim 4, wherein, a draining groove extending from a top of the supporting bracket to a bottom of the supporting bracket is provided on the supporting bracket.

8. The lamp with an electric control box of claim 4, wherein, the electric component includes a substrate and a battery, the substrate and the battery are stacked and electrically connected to each other.

9. The lamp with an electric control box of claim 8, further comprising: a solar panel, wherein, the electric control box, the lamp body and the supporting base are provided below the solar panel, and the solar panel is electrically connected to the substrate.

10. The lamp with an electric control box of claim 9, wherein, the electric control box is provided between the lamp body and the supporting base, and the front side surface of the housing faces toward the supporting base.

11. The lamp with an electric control box of claim 5, wherein, a draining groove extending from a top of the supporting bracket to a bottom of the supporting bracket is provided on the supporting bracket.

12. The lamp with an electric control box of claim 5, wherein, the electric component includes a substrate and a battery, the substrate and the battery are stacked and electrically connected to each other.

13. The lamp with an electric control box of claim 12, further comprising: a solar panel, wherein, the electric control box, the lamp body and the supporting base are provided below the solar panel, and the solar panel is electrically connected to the substrate.

14. The lamp with an electric control box of claim 13, wherein, the electric control box is provided between the lamp body and the supporting base, and the front side surface of the housing faces toward the supporting base.

15. An electric control box, comprises a heat dissipation box and an electric component, wherein, the heat dissipation box comprises:
a housing, wherein, the housing extends along a horizontal direction, and an accommodating space configured to accommodate the electric component is provided in the housing, the electric component is separated from an inner bottom wall of the housing by a distance;
an air inlet fan, wherein, the air inlet fan is provided close to a front side surface of the housing, and the air inlet fan is configured to draw external gas into the accommodating space;
an air outlet fan, wherein, the air outlet fan is provided close to the front side surface of the housing and is separated from the air inlet fan by a distance in a horizontal direction, the air outlet fan is configured to discharge gas inside the accommodating space to an exterior of the housing;
a protection unit, wherein, the protection unit includes supporting brackets and a protective covers; each supporting bracket is provided on an outer side of the front side surface of the housing, a perforation is provided on a middle portion of each supporting bracket, the perforation is configured to form a communication between the accommodating space and an exterior, each perforation is located close to the air inlet fan and the air outlet fan respectively; each protective cover is a semi-enclosed box with an opening provided at one end of the semi-enclosed box, each protective cover is covered on each supporting bracket, a least a portion of an inner wall of the protective cover is separated from the supporting bracket to form a gas channel communicated with the perforation and the housing.

16. The electric control box of claim 13, wherein, the supporting bracket is surrounded by the protective cover, and the inner side walls are separated from the side surfaces of the supporting bracket by a distance.

17. A heat dissipation box comprises a housing, wherein the housing extends along a horizontal direction, and an accommodating space is provided in the housing; the heat dissipation box further comprises:
an air inlet fan, wherein, the air inlet fan is provided close to a front side surface of the housing, and the air inlet fan is configured to draw external gas into the accommodating space;
an air outlet fan, wherein, the air outlet fan is provided close to the front side surface of the housing and is separated from the air inlet fan by a distance in a horizontal direction, the air outlet fan is configured to discharge gas inside the accommodating space to an exterior of the housing;
a protection unit, wherein, the protection unit includes supporting brackets and a protective covers; each supporting bracket is provided on an outer side of the front side surface of the housing, a perforation is provided on a middle portion of each supporting bracket, the perforation is configured to form a communication between the accommodating space and an exterior, each perforation is located close to the air inlet fan and the air outlet fan respectively; each protective cover is a semi-enclosed box with an opening provided at one end of the semi-enclosed box, each protective cover is covered on each supporting bracket, a least a portion of an inner wall of the protective cover is separated from the supporting bracket to form a gas channel communicated with the perforation and the housing; a drain hole facing downward is provided on a bottom of the protective cover, the drain hole is located close to an inner side wall of the protective cover facing toward the perforation, and an inner bottom surface of the protective cover is inclined toward a direction of the drain hole.

18. The heat dissipation box of claim 17, wherein, the front side surface of the housing is provided inclined with respect to a perpendicular direction, so that the drain hole faces toward the housing.

19. The heat dissipation box of claim 18, wherein, two mounting portions inclined with respect to each other are provided on the front side surface of the housing, distances between the two mounting portions are gradually increase in a direction away from the front side surface, the perforations are located on the two mounting portions respectively.
